(19) United States
(12) Patent Application Publication
(10) Pub. No.: US 2022/0227049 A1
(43) Pub. Date: Jul. 21, 2022

(54) METHOD AND DEVICE FOR 3D PRINTING WITH A NARROW WAVELENGTH SPECTRUM

(71) Applicant: Voxeljet AG, Friedberg (DE)

(72) Inventors: Daniel Günther, München (US); Christoph Scheck, Friedberg (DE); Lisa Brüller, Friedberg (DE); James Reeves, Friedberg (DE)

(21) Appl. No.: 17/703,574

(22) Filed: Mar. 24, 2022

Related U.S. Application Data
(63) Continuation of application No. 15/776,002, filed on May 14, 2018.

(30) Foreign Application Priority Data
Nov. 20, 2015 (DE) 10 2015 014 964.4

(51) Int. Cl. B29C 64/268; B33Y 10/00; B33Y 30/00; B29C 64/153

(52) U.S. Cl. CPC B29C 64/268; B33Y 10/00; B23K 26/144; B29C 64/153; B33Y 30/00

(57) ABSTRACT

The invention relates to a 3D printing method and a device with a narrow wavelength range.

### CLAIM OF PRIORITY

This application is a continuation of US Patent Application serial number 15/766,002 filed on May 14, 2018 which is a national phase filing under 35 USC § 371 from PCT Patent Application serial number PCT/DE2016/000399 filed on Nov. 16, 2016 and claim priority therefrom. This application further claims priority to German Patent Application Number DE 102015014964,4 filed on Nov. 20, 2015.

The invention relates to a method and a device for producing three-dimensional models or molded parts.

European Patent EP 0 431 924 B1 describes a process for producing three-dimensional objects based on computer data. In the process, a thin layer of particulate material is deposited on a platform and has a binder material selectively printed thereon by means of a print head. The particulate region with the binder printed thereon bonds and solidifies under the influence of the binder and, optionally, an additional hardener. Next, the platform is lowered by one layer thickness into a construction cylinder and provided with a new layer of particulate material, the latter also being printed on as described above. These steps are repeated until a certain desired height of the object is achieved. Thus, the printed and solidified regions form a three-dimensional object.

Upon completion, the object made of solidified particulate material is embedded in loose particulate material, from which it is subsequently freed. For this purpose, a suction device may be used, for example. This leaves the desired objects which then have to be freed from any residual powder, e.g. by brushing it off.

Other powder-based rapid prototyping processes, e.g. selective laser sintering or electron beam sintering, work in a similar manner, also applying loose particulate material layer by layer and selectively solidifying it using a controlled physical source of energy or radiation.

In the following, all these processes will be summarized by the term “three-dimensional printing method” or “3D printing method”.

This method allows various particulate materials, including polymeric materials, to be processed. However, it has the disadvantage that the particulate material bed cannot exceed a certain bulk density, which is usually 60% of the particle density. The strength of the desired components significantly depends on the achieved density, however. Insofar it would be required here for high strength of the components to add 40% or more by volume of the particulate material in the form of liquid binder. This is not only a relatively time-consuming process due to the single-droplet input, but it also causes many process-related problems, which are given, for example, by the inevitable shrinkage of the liquid volume during solidification.

In another form of 3D printing, which is known in the art as “high-speed sintering”, or HSS for short, solidification of the particulate material is effected by input of infrared radiation (IR radiation). The particulate material is thus bonded physically by a fusing process. In this case, advantage is taken of the comparatively poor absorption of thermal radiation in colorless plastic materials. Said absorption can be increased multiple times by introducing an IR acceptor or absorber into the plastic material. The IR radiation can be introduced by various means, e.g. a bar-shaped IR radiator, which is moved evenly over the construction field (sintering radiator). Selectivity is achieved by the specific and selective printing of the respective layer with an IR acceptor.

In the printed locations, the IR radiation thereby couples much better into the particulate material than in the unprinted regions. This results in selective heating within the layer beyond the melting point and, consequently, to selective solidification in these areas. This process is described, for instance, in EP 1 740 367 B1 and EP 1 648 686 B1 and will be abbreviated below as HSS.

Various materials are known from the laser sintering process which can be processed by this method as well. By far the most important material in this context is polyamide 12. There are several manufacturers for this material. The strengths achieved are excellent for layer construction methods.

The material is available as a fine powder which can be processed directly in this quality. Due to the manufacturing process, however, costs are high and may exceed the cost of standard polyamide by a factor of 20-30.

In the HSS process of the prior art, just as in laser sintering, the powder is brought to a temperature near the melting point of the material for processing. This causes the powder to “age” and limits its use in subsequent processes. A recycling rate results which considerably influences and increases process costs.

The precision of the parts is significantly influenced by process control. Thus, the homogeneity of the powder bed density and temperature in the construction space is decisive.

The radiation characteristic of conventional, thermal IR radiators can generally not be called “monochromatic”. On the contrary, their radiation consists of a wide, continuous spectrum of different wavelengths.

A suitable absorber must be found for the resulting wavelengths and added to the material to be selectively imprinted, also referred to as ink. This often limits the coloring of the ink. Moreover, the choice is often limited, so that poor efficiency may generally be assumed.

Furthermore, the power of the source of radiation is inextricably linked with the temperature of the filament or heating wire and, thus, the emitted wavelength. This is described by the Stefan-Boltzmann law and Wien's displacement law. Thus, power scaling has to take the wavelength shift into consideration. Furthermore, secondary radiation preferably occurs in the far IR range, because the filament or heating wire casings, such as e.g. quartz glass bodies, are also heated and thereby become emitters themselves. This is precisely the wavelength range in which polymers usually have absorption maxima.

In the visible range, in which excellent absorbers exist for different wavelengths (colors), thermal absorbers include considerable IR portions that do not heat selectively and, thus, heat the unprinted powder in an uncontrolled manner in the sense of the process. The aim of selectively influencing both types of areas—printed and unprinted—can be achieved only to a limited degree.

Any uncontrolled heating constitutes a source of waste heat. Such sources will reduce the efficiency of the device and, due to the sensitive process control, also the performance of the 3D printing process.

It is an object of the invention to provide a method and a device which reduce or help to completely avoid the disadvantages of the prior art. Another object of the invention is to design the method such that the heating of the “printed and unprinted” types of areas can be performed in a specific manner.

According to the invention, this object is achieved by a method of producing 3D molded parts, wherein particulate construction material is applied onto a construction field in a defined layer by means of a coater, one or more liquids or particulate material of one or more absorbers is/are selectively applied, energy is input by suitable means, resulting in selective solidification of the areas printed with absorber, at a solidification temperature or sintering temperature above the melting temperature of the powder, the construction field is lowered by one layer thickness, or the coater is raised by one layer thickness, these steps being repeated until the desired 3D molded part is produced, characterized in that at least the energy input of printed areas is effected by means of substantially monochromatic radiation or/and within a narrow wavelength spectrum having a width of 0.5 μm to 2 μm.

According to the invention, this object is further achieved by using sources of radiation as sintering radiators having a wavelength that can be characterized as substantially monochromatic. This may include special monochromatic discharge lamps, LASER light sources or LED light sources. All these types of radiators have a very narrow spectral distribution. Any additional heat radiation produced during the radiation generation process can be reduced by cooling.

It is also possible to use an area illuminated by means of a not necessarily monochromatic light source, characterized by a fluorescent material which then emits monochromatic radiation. This has the advantage of specifically using wavelengths which are not accessible by means of commercially available monochromatic light sources and/or whose use is not practical. Furthermore, this allows to achieve a more uniform intensity of the emitted radiation in relation to the area.

The use of monochromatic sources of radiation or of sources of radiation with a narrow wavelength spectrum further increases the selection of materials which are transparent for said radiation. This includes commercially available materials which can be used as diffusers so as to maximize the uniformity of radiation as well.

As a result, irradiation with higher-energy radiation is available, thus increasing the depth of penetration into the powder layer. This increases the bonding of the individual areas partly melted in the layer construction method, benefitting the solidity of the molded parts to be manufactured. Using the described sources of radiation allows to reduce not only the distance between the radiator and the respective area, but also the size of the radiator, so that more compact machine geometries are feasible and the energy efficiency can be considerably increased.

A radiator heating or cooling time, as in conventional sources of radiation in the visible or infrared range, is eliminated, thus considerably accelerating the layer construction process. This also eliminates the considerably increased aging of conventional sources of radiation resulting from frequent heating and cooling processes.

Having thus eliminated any slow response, the sources of radiation can be selectively activated and deactivated while passing over the area to be irradiated, e.g. according to a matrix process.

This allows selective temperature adjustment of the areas. Heat losses are limited, which consequently increases the overall efficiency of the device. This may be advantageous, in particular, in machines with temperature-sensitive components, because the machine room itself can be kept cooler.

Considering safety aspects, such as fire protection, the aforementioned improvements are also very advantageous due to the considerably reduced build-up of heat. Moreover, the aging or degradation of the particulate material used, which results from high temperatures, can also be further reduced in areas which are not to solidify, thus facilitating the removal of the solidified portions after the cooling process.

Since the radiator output is not coupled to the wavelength, the performance of the device can be increased without any problem. This will not affect the process itself.

Some of the above-described advantages can also be achieved using non-monochromatic light sources, provided their range is sufficiently narrow and they can be operated at higher temperatures than customary. This will reduce the bandwidth of the emitted radiation, as can be deducted from Planck's radiation law. A small size would enable more uniform irradiation and also allow areas to be left out which are not to be solidified, in particular because activation and deactivation times shorten as the emitter temperature increases.

The smaller power loss and size of the above-described radiators enables a nested design of emitters of different wavelengths, without having to forsake the uniformity of radiation intensity in relation to the area. Even a design using emitters of three different wavelengths is possible.

In one aspect of the invention, the narrow bandwidth of the emitters allows individual elements of the activator, in particular the carrier fluid, to be systematically stimulated. This allows liquid portions to be evaporated immediately after application, so that they do not remain in the molded part to be produced.

In the selective liquid application of one and the same absorber, controlled by the applied quantity, the much more systematic temperature control allows different temperatures to be achieved, so that when two different particulate materials with different sintering temperatures are used simultaneously in one single mixture, one type of particulate material may be partly melted, while the other remains unchanged. Thus, the property of the molded article can be specifically influenced by the quantity of absorber used.

Several terms according to the invention will be explained in more detail below.

A “molded article” or “part” in the sense of the invention means three-dimensional objects manufactured by means of the method according to the invention or/and the device according to the invention and exhibiting dimensional stability.

“Construction space” is the geometric location where the particulate material bed grows during the construction process by repeated coating with particulate material or through which the bed passes when applying continuous principles. The construction space is generally bounded by a bottom, i.e. the construction platform, by walls and an open top surface, i.e. the construction plane. In continuous principles, there usually is a conveyor belt and limiting side walls.

The “heating phase” refers to heating of the device at the beginning of the process. The heating phase is complete as soon as the required temperature of the device becomes stationary.

The “cooling phase” lasts at least until the temperature is so low that the parts are not subject to any significant plastic deformation when removing them from the construction space.

The “particulate materials” of use herein may be any materials known for powder-based 3D printing, in particular polymers, ceramics and metals. Particulate materials consisting of mixed materials or composites of different materials are also usable, as are particulate materials on the basis of renewable raw materials, such as cellulose fibers or wood powder, for example. The particulate material is preferably a free-flowing powder when dry, but may also be a cohesive, cut-resistant powder or a particle-charged liquid. In this specification, particulate material and powder will be used synonymously.

The “activator” or “absorber” in the sense of this invention is a medium which can be processed by an inkjet print head or any other device working in a matrix-like manner, which medium enhances the absorption of radiation for local heating of the powder. The “absorber” may also be in the form of particles, e.g. black toner. Absorbers may be applied uniformly or selectively, in different amounts. Thus, applying different amounts allows the strength in the construction material to be controlled and to selectively achieve different strengths, e.g. in the molded part to be produced. The strength ranges from a strength as in the part itself to a strength that is only insignificantly above that of the construction material without the absorber printed thereon. This allows temperature control in the construction field/construction space and also allows easy removal, if desired, of the jacket surrounding the produced part, which jacket serves the purpose of temperature control.

“IR heating” as used herein specifically means irradiation of the construction field by an IR radiator. The radiator may be either static or movable over the construction field by a displacement unit. Using the activator, the IR heating results in different temperature increases in the construction field.

“Radiation heating” generalizes the term “IR heating”. The absorption of radiation of any wavelength may heat a solid or a liquid.

“Area type” is an expression used to differentiate between unprinted and printed areas.

An “IR radiator” is a source of infrared radiation. Usually, incandescent filaments in quartz or ceramic housings are used to generate the radiation. Depending on the materials used, different wavelengths result for the radiation. In addition, the wavelength of this type of radiator also depends on the power output.

A “source of radiation” generally emits radiation of a specific wavelength or a wavelength range. A source of radiation with almost monochromatic radiation is referred to as a “monochromatic radiator”. A source of radiation is also referred to as an “emitter”. In the sense of the invention, radiators with a narrow wavelength range may also be used, with ranges being possible from 0.5 to 2 pm to 0.05 to 0.1 pm.

An “overhead radiator” in the sense of the invention is a source of radiation mounted above the construction field. It is stationary, but has an adjustable radiant power. It essentially ensures non-selective surface heating.

The “sintering radiator” is a source of radiation which heats the process powder to above its sintering temperature. It may be stationary. In preferred embodiments, however, it is moved over the construction field. In the sense of this invention, the sintering radiator is embodied as a monochromatic radiator.

“Sintering” is the term for the partial coalescence of the particles in the powder. In this system, the build-up of strength is connected with the sintering.

The term “sintering window” refers to the difference in temperature between the melting point occurring when first heating the powder and the solidification point during the subsequent cooling.

The “sintering temperature” is the temperature at which the powder first begins to fuse and bond.

Below the “recrystallization temperature”, powder once melted solidifies again and shrinks considerably.

The “packing density” describes the filling of the geometric space by solid matter. It depends on the nature of the particulate material and the application device and is an important initial parameter for the sintering process. In most cases, the packing density is not 100% and there are cavities between the particles of the particulate material and a certain porosity is present during application of the particulate material and in the final molded part.

The term “shrinkage” refers to the process of geometric shortening of a dimension of a geometric body as a result of a physical process. As an example, the sintering of sub-optimally packed powders is a process resulting in shrinkage with respect to the initial volume. Shrinkage can have a direction assigned to it.

“Deformation” occurs if the body is subject to uneven shrinkage in a physical process. Such deformation may be either reversible or irreversible. Deformation is often related to the global geometry of the component.

“Curling” as used in this specification refers to an effect resulting from the layer-wise approach of the described invention. This means that layers generated in quick succession are subject to different degrees of shrinkage. Due to physical effects, the compound then deforms in a direction which does not coincide with the direction of shrinkage.

The “grayscale value” refers to the amount of activator printed into the powder. According to the invention, different grayscale values can be printed onto the construction field in order to achieve different degrees of heating.

The “particulate materials” or “particulate construction materials” or “construction materials” of use herein may be any materials known for powder-based 3D printing, in particular polymers, ceramics and metals. The particulate material is preferably a free-flowing powder when dry, but may also be a cohesive, cut-resistant powder or a particle-charged liquid. In this specification, particulate material and powder will be used synonymously.

The “particulate material application” is the process of generating a defined layer of powder. This may be done either on the construction platform or on an inclined plane relative to a conveyor belt in continuous principles. The particulate material application will also be referred to below as “coating” or “recoating”.

“Selective liquid application” in the sense of the invention may be effected after each particulate material application or irregularly, depending on the requirements for the molded article and for optimization of the molded article production, e.g. several times with respect to particulate material application. In this case, a sectional image of the desired article is printed. In connection with the present invention, the absorber may be contained as a support or printing agent, dispersed or dissolved, in a liquid or ink.

The “device” used for carrying out the method according to the invention may be any known 3D-printing device which includes the required parts. Common components include coater, construction field, means for moving the construction field or other components in continuous processes, metering devices and heating and irradiating means and other parts which are known to the person skilled in the art and will therefore not be described in detail herein.

“Absorption” refers to the uptake by the construction material of thermal energy from radiation. The absorption depends on the type of powder and the wavelength of the radiation.

The “support” refers to the medium in which the actual absorber is present. This may be an oil, a solvent or generally a liquid. In this connection, reference is also made to the term “selective liquid application”.

“Radiation-induced heating” as used hereinafter means irradiation of the construction field by stationary or mobile sources of radiation. The absorber is adapted to the type of radiation and preferably optimized. This is intended to produce differences in heating between “activated” and “non-activated” powder. “Activated” means that, by the absorber printed therein, the temperature in these regions is increased as compared to the other regions in the construction space.

“Basic temperature” in the sense of the invention means the temperature which is adjusted in the construction space on the surface of the particulate material and in the printed particulate material by suitable means, e.g. an IR radiator. In this case, the basic temperature is selected so as to be suitable, with respect to the particulate material and in interaction with the absorber, to achieve selective solidification with positive material properties.

The construction material is always applied in a “defined layer” or “layer thickness”, which is individually adjusted according to the construction material and the process conditions. It is, for example, 0.05 to 0.5 mm, preferably 0.1 to 0.3 mm.

In further aspects, the object underlying the invention is achieved by a method which is characterized in that the substantially monochromatic radiation is selected or generated by one or more monochromatic discharge lamps, LASER light sources, LED light sources or/and by one or more areas which are characterized by a fluorescent material which emits monochromatic radiation upon irradiation or transmission.

In another preferred aspect, a narrow wavelength spectrum can achieve the object underlying the invention in that the narrow wavelength spectrum is between 0.5 μm and 1.5 μm, preferably between 0.1 μm and 0.2 μm.

Depending on the requirements and constructional features of the 3D printing device used, temperature control in the method according to the invention may be performed in different ways. For instance, an overhead radiator or/and a sintering radiator may be used. On the other hand, the method may be characterized in that an overhead radiator is used for basic heating and a sintering radiator is used to heat the printed areas to a temperature above the melting temperature.

Preferably, the method is performed such that a sintering radiator is used which has a wavelength for heating the printed areas to a temperature above the melting temperature and a wavelength for heating the unprinted areas to a temperature above the recrystallization temperature, wherein preferably no static overhead radiator is used, or a static overhead radiator is used which has a wavelength for heating the printed areas to a temperature above the melting temperature and a wavelength for heating the unprinted areas to a temperature above the recrystallization temperature, wherein preferably no movable sintering radiator is used.

The method may be further characterized in that the power of the individual elements can be adjusted and their adjustment may be based on the respective heating.

In another aspect, the method may be characterized in that, for specific heating of printed and unprinted areas, selective activation and deactivation of the sources of radiation is performed during a pass over the construction surface or/and that selective activation and deactivation of stationary sources of radiation is performed.

As the absorber, any suitable absorbing agent or mixture which is compatible with the other process conditions may be used alone or in combination with a carrier or further ingredients. Said absorber is preferably a liquid, preferably an oil-based ink containing carbon particles, e.g. XAAR IK821.

As a particulate construction material, a construction material which is usable together with the other components is used, preferably having an average particle size of 50-60 μm, preferably 55 μm, a melting temperature of 180-190° C., preferably 186° C., and/or a recrystallization temperature of 140-150° C., preferably 145° C., said material preferably being polyamide 12, more preferably PA2200° or Vestosint1115®

When performing the method, heating takes place such that only the areas printed with absorber interconnect by partial melting or sintering, wherein the construction material is used as a powder or as a dispersion, or/and wherein the construction field and/or the applied construction material is temperature-controlled or/and wherein the absorber comprises radiation-absorbing components, plasticizers for the particulate construction material or/and one or more substances interfering with recrystallization.

The method is further characterized in that the amount of the absorber or absorbers is regulated via grayscale values of the print head or via dithering methods.

The selectively applied agent is applied using suitable agents and in a suitable and necessary quantity, the liquid preferably being applied selectively by means of one or more print heads, the print head(s) preferably having an adjustable drop mass, or/and the print head(s) selectively applying the liquid in one or both directions of movement, or/and the particulate construction material being selectively solidified, preferably selectively solidified and sintered.

Finally, one aspect of the invention is a device which is suitable to carry out a method according to the invention.

In the following, the invention will be described in its various aspects.

The key object of specifically heating the respective types of areas is preferably achieved by the use of monochromatic sources of radiation.

The prior art method consists of the steps of layering, printing, exposure to radiation and lowering. The first step is analogous to the layering in known powder-based 3D printing. Powder is placed in front of a blade, applied onto a construction platform and smoothened by the blade. In this case, the layer thickness determines the positions of the construction platform in two successive coating operations.

Next, the layer is printed. In the method mentioned here, liquids are applied by an inkjet print head. Part of the liquid is an activator which causes local heating of the powder upon exposure to radiation.

The layer thus printed is then scanned by a radiation source and thereby selectively heated. When a thermal source of radiation is used, the entire powder is heated strongly. However, the temperature increases particularly in activated areas such that the particles begin to sinter. Using monochromatic radiators, this process can be better controlled and the respective types of areas can be acted upon specfically.

After this step, the construction field is lowered by one layer thickness. All of the above-mentioned steps are then repeated until the desired part is obtained.

The construction field or the unprinted areas are maintained at a temperature near the sintering temperature. On the one hand, the additional energy for sintering the powder is then low and can be introduced by gently acting means. On the other hand, the temperature surrounding the part is so high that the temperature does not drop below the recrystallization temperature, even in the peripheral areas of the part, as the construction process progresses and, consequently, does not disrupt layering.

In addition to the source of radiation scanning the construction field, an additional, stationary source of radiation may be optionally present above the construction field. The additional source of radiation acts whenever the construction field is not covered by a unit, such as the coater or the print head. This overhead radiator, as it is called, is preferably controlled so as to set a constant temperature on the construction field. For example, a pyrometer sensor may be used to determine the actual temperature. In such an arrangement, the overhead radiator constitutes the central temperature control component.

The overhead radiator performs the function of controlling the process temperature. However, such control may also be achieved by the sintering radiator. In this case, radiators adapted for heating unprinted areas must be used and their power output is controlled according to the requirements of the process. Also, the printed areas necessary for sintering and low-shrinkage construction must be heated by radiation.

Thus, both types of radiators, i.e. sintering radiators and overhead radiators, can be mutually exchanged when using monochromatic light sources according to the invention. On the whole, only one suitable source of radiation which does justice to both types of areas by different discrete wavelengths needs to be employed. This source of radiation can be moved over the construction field. However, the movement is not a stringent requirement.

This allows arrangements to be found which enable much shorter layering times. Without control via the overhead radiators, the processes of printing and coating can be performed sequentially virtually without any delay.

This method also allows static radiation panels to be implemented, which combine the functions of the overhead and sintering radiators. If a geometric movement of the radiation intensity makes sense geometrically, said radiators may be assembled from switchable sections. For example, radiators can be deactivated in some sections in order, for example, to protect sensitive components such as the print head during its movement.

The generally higher efficiencies in radiation generation and radiation absorption lead to lower temperatures in the device. This is advantageous for protecting sensitive components.

In the following, preferred embodiments will be further described, which are not to be construed as limiting the disclosure contained herein. Furthermore, all features of the disclosure contained in the examples are to be construed such that they may also be combined individually and in any combination, in a suitable manner, without being restricted to the individual examples and the combinations contained therein.

Preferred embodiments

General, detailed description of the device

The device required in order to carry out the invention is closely modeled on a 3D printer for powder-based printing. In addition, further process units are used for temperature control and imprinting of the process liquids.

At the beginning of the process, the entire device is heated up. For this purpose, all heating elements are used to increase the temperature. The heating phase is complete as soon as the temperature remains constant in all measurement locations of the system.

The individual heating systems of a preferred embodiment of the invention will be described below:

The construction platform (102), on which the particulate material is deposited in the process and by which the layer thickness of the layers (107) is adjusted, can be heated by various systems. A preferred embodiment uses an electric resistance heater (504). Also, preferably, the latter is provided as a planar heating film, based on considerations of a homogeneous heating effect. The effect of this heating is registered and controlled by a sensor. The sensor is connected directly with the construction platform. Conveniently, the construction platform itself is made of metal, preferably aluminum. An insulation (506) covers the construction platform (102) downwardly.

The construction platform may also be heated by a fluid. For this purpose, heating coils (504) are installed below the preferably metallic construction platform. Further below, an insulation (506) is disposed in order to homogenize the heating effect.

A heat transfer oil, for example, flows through the heating coils. Preselecting the oil temperature allows exact temperature adjustment. Very high-quality temperature control can be achieved by ensuring a sufficiently high flow rate and adjusting the power.

The construction platform (102) is moved in the construction container (110) as it is called. The container may be designed to be removable from the device. In this manner, great temporal machine efficiency can be achieved, as a second construction container can be used in the device while unpacking the parts.

The construction container (110) is also heated. The same techniques can be used for the construction platform. The container itself is preferably made of metal again, preferably of aluminum to ensure good heat conduction. The actual active heating (504) is in turn backed by an insulation (503). This allows the effect to be enhanced, while increasing homogeneity.

A plug-in system is preferably arranged between the device and the construction container for power connection. This may include an electrical connection or a connector for liquids.

The next essential heating system of a device according to the invention is the overhead radiator (108). According to the invention, the overhead lamp (108) is preferably disposed above the construction field and irradiates the construction field perpendicularly. Also preferred are laterally mounted radiators which irradiate the construction field at a certain angle. Such a construction is preferred in order to minimize the shading effect of the coater or the print head.

According to the invention, the overhead radiator (108) may be equipped with monochromatic radiators (603, FIG. 7). These may be discharge lamps, LASER sources of radiation or LED radiators. The selection depends on the activator selected and the combination which is best, considering the nature of the process, according to the wavelength.

According to the invention, the overhead radiator (108) may also be equipped with thermal radiators (FIG. 6) which should have minimal selectivity. For example, ceramic radiators with an extremely large wavelength may be used. The specific heating of the different types of areas is then effected by the sintering radiator (109).

It is favorable for the method to operate the overhead radiator (108) in a controlled manner. For this purpose, the use of a pyrometer (508) as the sensor may be preferred. The pyrometer is directed towards a peripheral area of the construction field, which the control system ensures is not a region printed with activator.

In a preferred embodiment of the invention, the actual sintering is carried out by a sintering radiator (109, 501) carried along with the coater. Said radiator heats the construction field as it passes over the latter. The radiator may be used to heat the freshly printed powder or an already covered powder layer. According to the invention, a monochromatic source of radiation (400) is used here, which may also, optionally according to the invention, emit several discrete wavelengths or may optionally be composed of radiators having different wavelengths (401, 402). A nested construction is preferable (FIGS. 4a, 4b). This source of radiation may consist of discharge lamps, LASER sources of radiation or LED radiators. Another option is to use a fluorescent surface (601) which is illuminated by a not necessarily monochromatic source of radiation (604) and thereby emits monochromatic radiation (602) of a specific wavelength corresponding to the absorption of the activator (FIG. 8).

In a preferred embodiment of the device, the powder is preheated before being applied onto the already existing powder surface so as to prevent excessive cooling of the layer. An electric resistance heater (507) in the coater (101) is also suitable to preheat the powder.

In principle, all units heated by contact heaters can also be heated indirectly by infrared radiation. Particularly preferably, the coater is heated by radiation if strong vibrations occur.

Preferably, the following sequence of process steps is carried out by the device after the heating phase: a powder layer is formed by the coater (101) on the construction platform (FIG. 1A). Optionally, depending on the design of the machine, the new layer can be additionally heated by the sintering radiator (109,501). Next, this layer is printed on by one (100) or several inkjet print heads (100) (FIG. 1 B). Then, the construction platform (102) is lowered (FIG. 1D). Now, the printed layer is heated by the sintering lamp (109,500) and then covered with powder again.

This operation is repeated until completion of the parts (103) in the construction container (110). Then the cooling phase follows. This phase preferably takes place in the construction container which is then supplied with energy outside the device.

FIG. 2 shows temperature diagrams. FIG. 2A schematically depicts the profile of the energy emitted by the powder when it is heated and cooled again in one cycle. During heating, significant absorption of energy occurs at a certain temperature. This is where melting or sintering of the material occurs (sintering temperature). For polyamide 12, which is suitable for laser sintering, this temperature is approx. 185° C. During cooling, there is also a significant point considerably below the sintering temperature (recrystallization temperature). This is where the molten material solidifies.

FIGS. 2B and 2C show the temperature profile during a process run according to a prior art method. FIG. 2B shows the temperature profile in the unprinted area. Using the sintering radiation source produces heating and cooling phases in the otherwise constant profile. In the unprinted area, the temperature never reaches the sintering temperature.

FIG. 2C shows the profile in the printed area. Here, the variations are more marked. The process is controlled at least such that the sintering temperature is briefly exceeded, so that part of the powder is melted and remains molten. Excessive heating causes all of the powder to melt in this area, resulting in massive warping. Excessive cooling of the printed area must also be avoided, because otherwise recrystallization will start, and then all shrinkages due to the now possible power transmission will lead to geometric warping (curling), which may make the further process impossible.

Staying precisely within this “process window” between the melting temperature and the recrystallization temperature is decisive for the quality of the parts. In this context, different boundary conditions apply to the printed and unprinted areas. The use of monochromatic sources of radiation facilitates temperature control between both temperatures considerably.

In particular, the exemplary embodiments describe how to use the advantages of this source of radiation in the described process.

### BRIEF DESCRIPTION OF THE DRAWINGS

FIG. 1. Method according to the state of the art, using thermal radiators.

FIG. 2A. Schematic energy input and output curves of a powder such as polyamide 12.

FIG. 2B. Temperature curves showing liquidus and solidus temperatures of the unprinted area type.

FIG. 2C. Temperature curves showing liquidus and solidus temperatures of the printed area type.

FIG. 3A. High-resolution, schematic representation of the temperature of the unprinted area type using a thermal source of radiation in the sintering radiator unit.

FIG. 3B. High-resolution, schematic representation of the temperature of the unprinted area type using a monochromatic source of radiation in the sintering radiator unit.

FIG. 4A. Arrangement of an LED source of radiation with different wavelengths.

FIG. 4B. Further possible arrangement.

FIG. 5. Sequence of a process according to the invention using a device without an overhead radiator;

FIG. 6. Device for carrying out the method according to the invention using a monochromatic LED sintering radiator.

FIG. 7: Device for carrying out the method according to the invention using a monochromatic sintering radiator and a monochromatic overhead radiator.

FIG. 8: Transformation of radiation from the sintering lamp by a fluorescent medium.

FIG. 9: Spectral distributions of various thermal sources of radiation and of genuinely monochromatic sources of radiation.

Further preferred exemplary embodiments:

### Example 1

### Device Comprising a Sintering Lamp which includes LED Radiators of One Wavelength and a Thermal Overhead Lamp

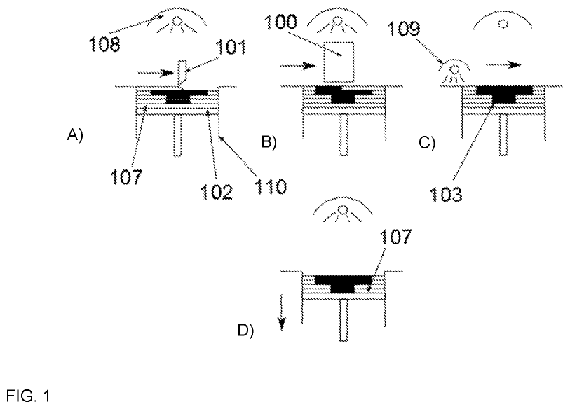

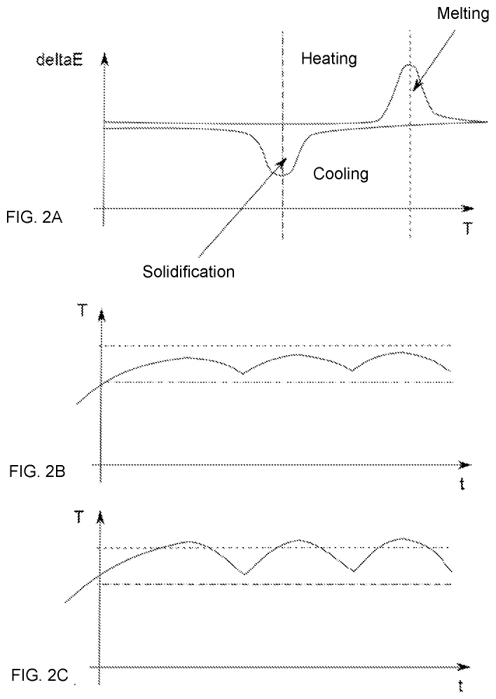

According to FIG. 1A, the construction process or process cycle begins with the coating of one powder layer onto the construction platform. The powder is heated by the overhead radiator (108) already during the coating process performed by the coater (101), unless optically masked by the coater (101). The sintering radiator (109), which only provides radiation resulting in good heating of the printed area, is not activated in this step.

The overhead radiator (108) includes a measuring device designed to control the surface temperature of the construction field. Ideally, the measuring device is embodied as a pyrometer (508) which can determine the temperature in a contactless manner. The control has to make allowance for the fact that the measuring device is masked time and again by the print head (100) and the coater (101). This may be done by deactivating the measurement function or by using insensitive control loop parameters.

In a second step, the activator is applied by the print head (100) which is adjusted precisely to the wavelength of the source of radiation. The image applied by the print head (100) onto the particulate material corresponds to the cross-section of the current molded article. At the beginning of a process, it is often required to print a base layer. In this case, the print head prints on the entire area provided as the construction surface.

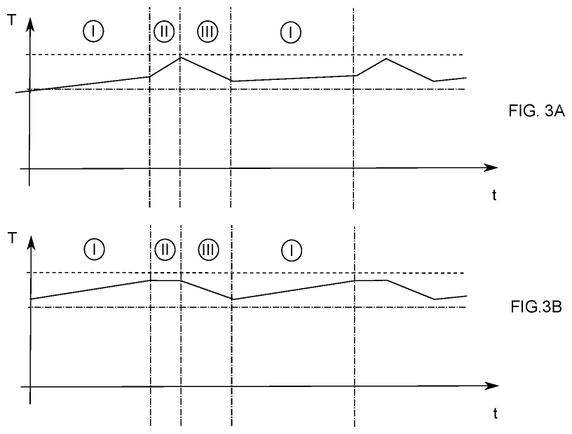

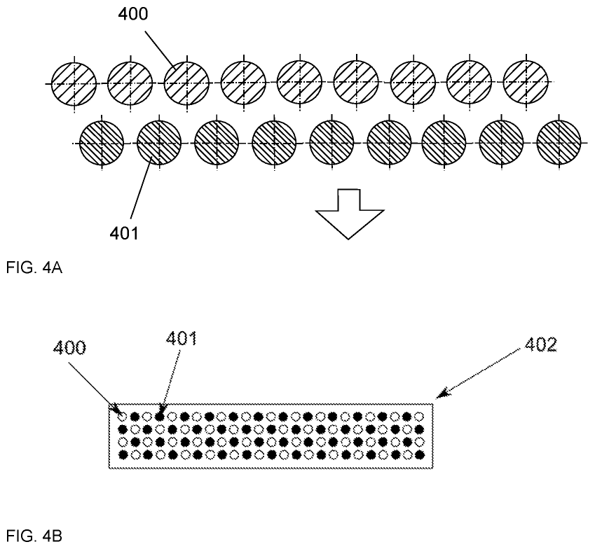

The third step is the sintering pass. For this purpose, the sintering radiator unit (109) is activated and passed over the construction field. The power of the source of radiation and its speed determine the radiation power on the construction field. In contrast to the prior art, the single-wavelength sintering radiator (500) does not heat unprinted areas during this pass. Thus, the temperature of the printed areas increases while unprinted areas slowly cool down due to the energy loss by radiation (FIG. 3B, area II).

The fourth step is the lowering of the construction platform (102) by the thickness of one powder layer (107). During this process, the construction field is open to the overhead radiator (108), allowing temperature readjustment. After this, the process cycle starts over with the coating process.

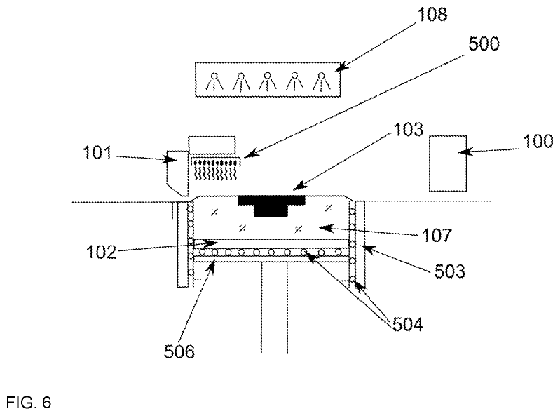

FIG. 6 describes a device for implementing the process mentioned in the example. The overhead radiator (108) is embodied as a thermal source of radiation. The sintering radiator is composed of small-sized individual LED radiators (400 or 500). The temperature of the construction container bottom and the construction platform is controlled by resistance heaters (504). In the device serving as an example the coater (101) and the sintering radiator unit (109) are connected. This unit and the print head (100) can be moved separately over the construction field.

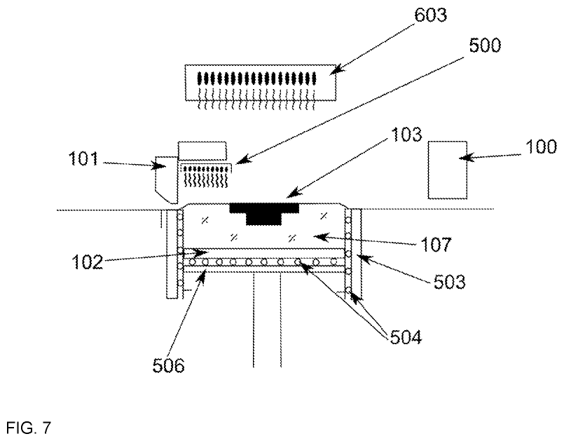

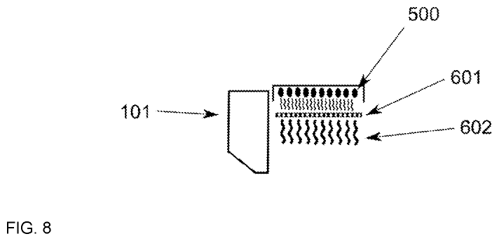

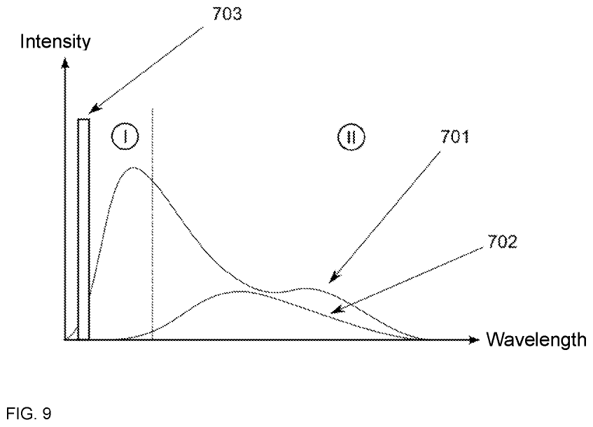

FIG. 7 shows a specific embodiment of this example. Here, the overhead radiator is also equipped with an LED source of radiation. This generates much less waste heat in the machine than in the prior art devices.

### Example 2

### Device of a Sintering Radiator Unit which includes LED Radiators having Two Wavelengths and No Overhead Lamp

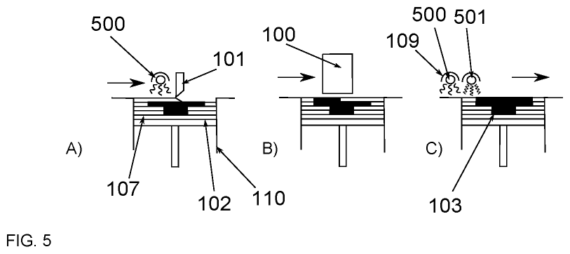

According to FIG. 5, the construction process or process cycle begins with the coating of one powder layer onto the construction platform (102). The sintering radiator (501) of the unit (109), which also provides radiation resulting in good heating of the unprinted area, is activated in this step and heats the powder to a basic temperature below the melting temperature but above recrystallization temperature of the powder. The energy supply for this is controlled by the power and the traversing speed.

Favourably, the temperature generated is measured and adjusted.

In a second step, the activator is applied which is adjusted precisely to the wavelength of the source of radiation (500) for the printed areas. The image applied by the print head (100) onto the powder corresponds to the current molded article. At the beginning of a process, it is often required to print a base layer. In this case, the print head prints on the entire area provided as the construction surface.

The third step is the sintering pass. For this purpose, the sintering unit (109) is activated and passed over the construction field. The power of the source of radiation and its speed determine the radiation power on the powder bed. In contrast to the prior art, the unit having two wavelengths (500,501) can specifically influence unprinted and printed areas during this pass. Thus, the temperature of the printed areas increases while the energy loss by radiation in the unprinted areas can be compensated for.

The fourth step is the lowering of the construction platform (102) by one layer thickness and is kept extremely short in this exemplary process. There is no adjustment here and any delay leads to energy loss by thermal radiation. Therefore, this step is not shown in the drawing.

### LIST OF REFERENCE NUMERALS

100 print head

101 coater

102 construction platform

103 parts

107 layers

108 overhead radiator

109 sintering radiator unit

110 construction container

400 monochromatic radiator in sintering unit

401 monochromatic radiator of a different wavelength in sintering unit

402 sintering radiator unit with radiators in nested design

500 monochromatic sintering radiator

501 sintering radiator of a different wavelength

503 insulation for construction container

504 resistance heater or heating coil

506 downward insulation of construction platform

507 resistance heater for coater

508 pyrometer

601 material with fluorescent layer

602 secondary radiation emitted by fluorescent layer

603 overhead radiator, embodied by monochromatic radiators

604 radiation on fluorescent layer

701 typical radiation spectrum of conventional radiators with secondary peak

702 radiation spectrum of conventional radiators at lower power

703 monochromatic radiation

What is claimed is:

1. A method of producing 3D molded parts, wherein
particulate construction material is applied onto a construction field in a defined layer by means of a coater,
one or more liquids or particulate material of one or more absorbers is/are selectively applied,
energy is input by suitable means, resulting in selective solidification of the areas printed with absorber, at a solidification temperature or sintering temperature above the melting temperature of the powder,
the construction field is lowered by one layer thickness, or the coater is raised by one layer thickness, these steps being repeated until the desired 3D molded part is produced,
characterized in that at least the energy input of printed areas is effected by means of substantially monochromatic radiation or/and within a narrow wavelength spectrum having a width of 0.1 μm to 0.2 μm.

2. The method according to claim 1, wherein an overhead radiator is used for basic heating and a sintering radiator is used to heat the printed areas to a temperature above the melting temperature.

3. The method according to claim 2, wherein the sintering radiator has a wavelength for heating the printed areas to a temperature above the melting temperature and a wavelength for heating the unprinted areas to a temperature above the recrystallization temperature.

4. The method of claim 1, wherein no static radiator is used or wherein a static radiator having a wavelength for heating the printed surface to a temperature above the melting temperature and having a wavelength for heating the unprinted surface to a temperature above the rectrystallization temperature is used.

5. The method of claim 3, wherein no movable sintering radiator is used.

6. The method of claim 2, wherein the power of the respective elements can be adjusted and the respective heating can be regulated.

7. The method of claim 1, wherein for selective heating of printed and unprinted areas, selective activation and deactivation of sources of radiation is performed during a pass over the construction surface.

8. The method of claim 1, wherein selective activation and deactivation of stationary sources of radiation is performed.

9. The method of claim 1, wherein the absorber is a liquid.

10. The method of claim 9, wherein the liquid is an oil-based ink containing carbon particles.

11. The method of claim 1, wherein the melting temperature is 180-190° C. or the recrystallization temperature is 140-150° C.

12. The method of claim 1, wherein the melting temperature is 180-190° C. and the recrystallization temperature is 140-150° C.

13. The method of claim 1, wherein
heating takes place such that only the areas printed with absorber connect by partial melting and sintering; or
the construction material is in the form of a powder or dispersion; or
the temperature of the construction field is controlled; or
the temperature of the material applied is controlled; or
the absorber comprises radiation-absorbing components, plasticizers for the particulate construction material or one or more substances for interfering with recrystallization.

14. The method of claim 1, wherein
heating takes place such that only the areas printed with absorber connect by partial melting and sintering; and
the construction material is in the form of a powder or dispersion; and
the temperature of the construction field is controlled; and
the temperature of the material applied is controlled; and
the absorber comprises radiation-absorbing components, plasticizers for the particulate construction material or one or more substances for interfering with recrystallization.

15. The method of claim 1, wherein the liquid is selectively applied by means of one or more print heads.

16. The method of claim 15, wherein the amount of the absorber or absorbers is regulated via grayscale values of the print head or via dithering methods.

17. The method of claim 15, wherein the one or more print heads are adjustable in terms of droplet mass.

18. The method of claim 15, wherein the particulate construction material is selectively solidified and sintered.

19. The method of claim 18, wherein the one or more print heads selectively apply the liquid in one direction of travel.

20. The method of claim 18, wherein the one or more print heads selectively apply the liquid in both directions of travel.
